(19) United States
(12) Patent Application Publication
(10) Pub. No.: US 2015/0081488 A1
(43) Pub. Date: Mar. 19, 2015

(54) MARKETING INCLUSION LIST MANIPULATION

(71) Applicant: Cellco Partnership (d/b/a Verizon Wireless), Arlington, VA (US)

(72) Inventors: Nancy R. Turner, Alexander, AR (US); Satish Kumar Hosanagara, Flanders, NJ (US); Scott Sheftic, Cerritos, CA (US)

(73) Assignee: CELLCO PARTNERSHIP (D/B/A VERIZON WIRELESS), Arlington, VA (US)

(21) Appl. No.: 14/030,481

(22) Filed: Sep. 18, 2013

(51) Int. Cl. G06Q 30/02

(52) U.S. Cl. CPC G06Q 30/02
USPC 705/34

(57) ABSTRACT

A system may include a service data warehouse configured to execute an inclusion list module to perform operations including receiving opt-out data from a billing system of a subscriber network, the opt-out data associated with use of subscriber information by at least one third-party information service, receiving an eligible subscriber list from an enterprise data warehouse of the subscriber network; and generating a customer inclusion list from the eligible subscriber list and the opt-out data, the customer inclusion list including a listing of subscribers identifiers of subscribers of the subscriber network who have opted into use of the at least one third-party information service of the subscriber network. The system may further include a notification system configured to provide privacy notices to subscribers, and automatically opt the subscribers in or out of inclusion on the customer inclusion list based on subscriber receipt of the privacy notices.

### BACKGROUND

An opt-out list is a blacklist that includes a listing of people or entities who do not wish to be included as recipients of messages or associated with a service. An opt-in list is a whitelist including a listing of those who do wish to be included. As one example, the United States Do-Not-Call Registry operated by the United States Federal Trade Commission is an opt-out list used by individuals to limit their exposure to certain types of telemarking calls. Opt-in or opt-out lists may be desirable for consumers, but are difficult to update and distribute to the services that use them.

### BRIEF DESCRIPTION OF THE DRAWINGS

FIG. 1 illustrates an exemplary system for the creation of a customer inclusion list.

FIG. 2 illustrates an exemplary process flow for the providing of privacy notices to an initial base of subscribers.

FIG. 3 illustrates an exemplary process flow for the providing of privacy notices for new customers.

FIG. 4 illustrates an exemplary process flow for the providing of privacy notices for the addition of subscriber sub-accounts.

FIG. 5 illustrates an exemplary process flow for the providing of opt-out preference updates for subscribers.

FIG. 6 illustrates an exemplary process flow for the automatic removal of subscribers from inclusion in the customer inclusion list.

FIG. 7 illustrates an exemplary process for generation of the customer inclusion list.

FIG. 8 illustrates an exemplary process for utilization of the customer inclusion list to filter subscriber data for use by opt-in services.

### DETAILED DESCRIPTION

Many types of subscriber information are available to network service providers, such as subscriber billing information, mobile web and application usage, and location information related to where subscriber usage is being performed. For example, a network service provider may collect data when mobile subscribers browse or use mobile applications on their mobile devices, the data including what sites were visited, what applications were used, lengths of time spend performing the usage, and where the mobile device was located during the usage. By combining these sources of information with demographic and behavioral information regarding the subscribers (e.g., from marketing information vendors such as Experian™ or Acxiom™), a system may determine aggregate intelligence about subscriber behavior and characteristics over the subscriber network. The aggregated data about the subscribers may be extrapolated from the group of subscribers to the population at large, and used to for purposes such as to provide reports allowing marketers and other viewers to gain insight into their current or prospective customers.

To protect the privacy of the subscribers to the network service provider, the provider may utilize an opt-in mechanism to allow subscribers to opt into or out of use of their information in aggregate form by third party or other opt-in services. For example, a marketing report service may utilize the opt-in mechanism to allow subscribers to set their opt-out preferences specifying whether their information to be used in aggregate form in marketing reports and for targeted advertising. The opt-in list may be referred to herein as a customer inclusion list, and may include a master reference list of all subscribers who may be included in the reporting data. At various stages of a data collection and loading process of data gathering by the network service providers, subscriber data may be matched against the customer inclusion list, such that data related to the subscribers who do not appear on the customer inclusion list will not be made available for use by the third party or other opt-in services.

The system may utilize an automated tool to schedule the generation of the customer inclusion list. For example, the system may be configured to generate the customer inclusion list automatically on a periodic basis (e.g., daily, weekly), enabling the system to quickly recognize eligible new subscribers and remove any subscribers with a change in eligibility status (e.g., those with a change to their opt-out preferences). In constructing the list, the system may begin by excluding a number of categories of subscribers defined as being ineligible. These categories may include business account holders (e.g., identified by accounts with an indicator that it is receiving a corporate discount, or accounts with more than a predefined number of sub-accounts or lines); federal, state or local government accounts; and pre-paid accounts, as some examples. Moreover, accounts that have disconnected from the service or changed categories such that they are no longer eligible (such as a personal account migrating to a business account) may also be excluded. Categories of accounts such as pre-paid, governmental and business accounts may be excluded because they typically are not associated with useful subscriber name or profile information (making the data unhelpful for use in third-party applications such as marketing or advertising), or because their data may be considered sensitive and therefore inappropriate to track.

To facilitate the receipt of subscriber opt-out preferences, the system may provide privacy notices to subscribers describing subscriber information to be collected and its intended use (e.g., for aggregate business and marketing reports), as well as the steps subscribers could take to decline to participate. In some cases, the privacy notice may be program-specific, while in other cases a generic privacy notice may be provided. The privacy notice may explain details of the opt out process, and may provide information with respect to how to do so, such as by mentioning privacy control options presented on subscriber account pages or phone numbers or other mechanisms by which the subscribers may access and update their opt-out preferences. The privacy notice may be provided in one or more languages, depending on the language of the subscriber base.

To ensure subscribers have an opportunity to opt out, the system may be further configured to remove subscribers who have not received a prepared privacy notice or who have received the privacy notice and who opted out. As discussed in detail below, an exemplary proactive subscriber notification process may include multiple ways for subscribers to indicate their desire to opt out. For example, system may be configured to receive opt out preferences from the subscribers through various sources, such as by way of a service website, at kiosks located in retail stores of the service, through the user account options accessible through account management software available in subscriber devices, or through customer care services provided by the service (e.g., via help desk personnel or via interactive voice response systems). The system may be configured to maintain records of the eligible subscribers' notification dates, notification methods employed and associated attempts to reach the subscribers to use in the generation of the customer inclusion list.

In some cases, subscribers may have multiple accounts or sub-accounts (e.g., multiple lines of phone service). In such cases, the subscribers may indicate an opt-out preference for each account or sub-account. For example, if the subscriber adds a line or changes a telephone number, the subscriber may be responsible for updating their opt-out privacy choices for the additional or updated sub-account. In other cases, the system may include an opt-out preference across multiple or all subscriber accounts, or may apply a default specified opt-out preference to the subscriber's new accounts or sub-accounts when they are created. The privacy notice may provide information regarding the handling of multiple accounts or sub-accounts to the subscribers. In some cases, the contents of the privacy notice may vary according to the subscriber details associated with the account or sub-account. For example, a sub-account associated with a subscriber under eighteen years old or under thirteen years old may receive a different privacy notice from a subscriber over the age of eighteen. In certain other cases, the privacy notice for sub-accounts for subscribers under a certain age may be provided to a primary account holder rather than to the user of the sub-account.

If the tool fails or a customer inclusion list is not generated at the expected time, the system may be configured to generate an alert to be followed up by a service team to attempt to resume generation of the customer inclusion list (e.g., within twenty-four hours or within the next periodic update). In some cases, subsystems utilizing the customer inclusion list may be configured to use a previous version of the customer inclusion list until the automated process is corrected and a new version of the customer inclusion list is delivered. This may result in some delay of receipt of subscriber opt-out decisions, but the previous version of the customer inclusion list may capture the majority of subscriber opt-out preferences.

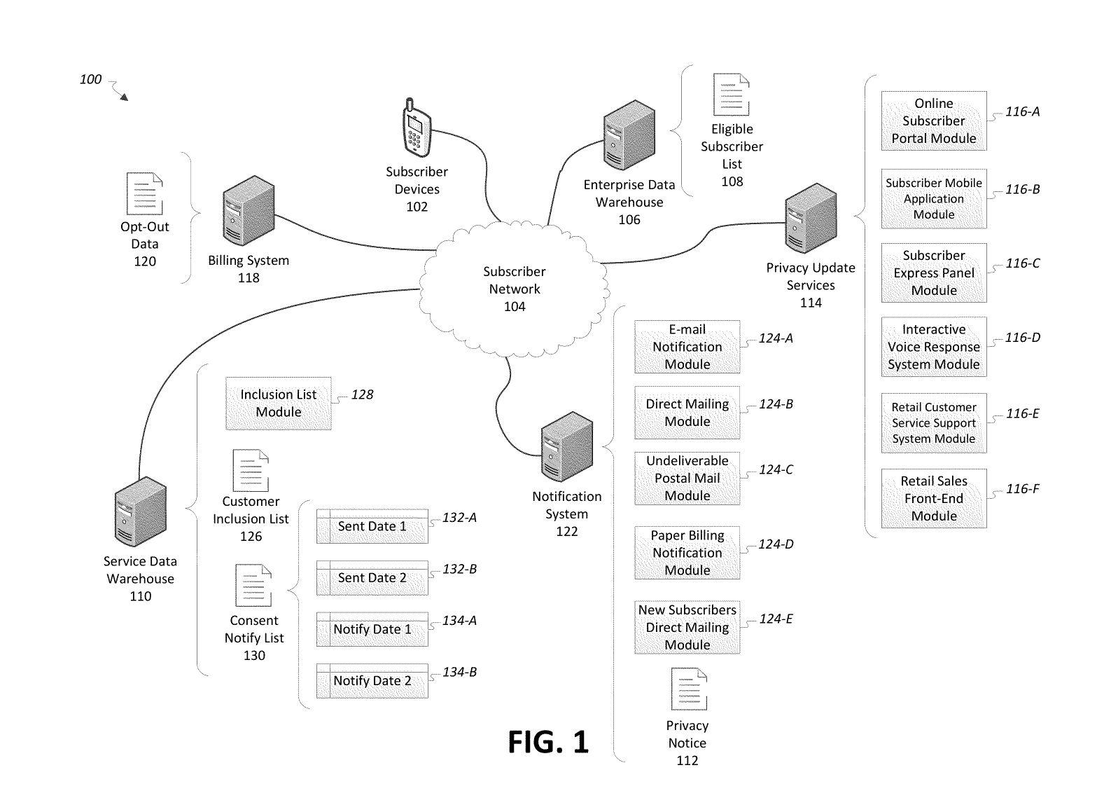

FIG. 1 illustrates an exemplary system 100 for the creation of a customer inclusion list 126. The system 100 includes an enterprise data warehouse 106 storing an eligible subscriber list 108, and a billing system 118 storing opt-out data 120 regarding subscriber devices 102 authorized to use the subscriber network 104. The system 100 further includes a service data warehouse 110 configured to store a consent notify list 130 including sent date 132 and notify date 134 information regarding the subscribers, as well as the customer inclusion list 126. To allow subscribers to provide opt-out preferences, the system includes privacy update services 114 including various privacy update modules 116 configured to allow the subscribers to update their opt-out preferences, such as an online subscriber portal module 116-A, a subscriber mobile application module 116-B, a subscriber express panel module 116-C, an interactive voice response system module 116-D, a retail customer service support system module 116-E and a retail sales front-end module 116-F. The system 100 also includes a notification system 122 including various notification modules 124 configured to provide and manage privacy notices 112, such as an e-mail notification module 124-A, a direct mail notification module 124-B, an undeliverable postal mail opt-out module 124-C, a paper billing notification module 124-D, and a direct mailing for new subscribers notification module 124-E. The system 100 further includes an inclusion list module 128 executed by a processor of the service data warehouse 110 and configured to maintain the customer inclusion list 126. The system 100 may take many different forms and include multiple and/or alternate components and facilities. While an exemplary system 100 is shown in FIG. 1, the exemplary components illustrated in FIG. 1 are not intended to be limiting. Indeed, additional or alternative components and/or implementations may be used.

The subscriber devices 102 may be any devices configured to be used by subscribers to interact with services and other subscriber devices 102. Exemplary subscriber devices 102 may include any of various models of networked device, such as voice over Internet protocol (VoIP) phones, mobile telephones, “softphone” software applications, media content processing systems such as cable set top boxes, computers such as laptops, desktops, and tablet devices, or other types of computing devices capable of executing applications and communicating with network services.

The subscriber network 104 may provide communications services, including packet-switched network services (e.g., Internet access, VoIP communication services) to the subscriber devices 102. Exemplary subscriber networks 104 may include the public switched telephone network (PSTN), a VoIP network, a cellular telephone network, a fiber optic network, and a cable television network. To facilitate communications, each subscriber device 102 on the subscriber network 104 may have its own device identifier used to indicate, reference, or selectively connect the subscriber's device 102 to the subscriber network 104. Exemplary device identifiers may include telephone numbers, MDNs, common language location identifier (CLLI) codes, subscriber identity module (SIM) card integrated circuit card (ICCID) or international mobile subscriber identity (IMSI) identifiers, device Internet protocol (IP) addresses, device media access control (MAC) addresses, input strings or device-associated usernames, and universal resource identifiers (URIs), as some possibilities.

The enterprise data warehouse 106 may be configured to house subscriber data used for purposes such as marketing and data analytics. The enterprise data warehouse 106 may further house subscriber related data such as name, postal address, demographic details, contact phone numbers, and contact e-mail addresses. The enterprise data warehouse 106 may be configured to filter the housed subscriber data to create an eligible subscriber list 108. The filtering may be performed to create an eligible subscriber list 108 including data on a subset of the subscribers, filtered according to criteria including the exclusion of one or more of: business account holders (identified by accounts with an indicator that it is receiving a corporate discount, or accounts with more than a predefined number of sub-accounts or lines), federal/state/local government accounts, pre-paid accounts, and accounts that have disconnected from the service provider or that have changed categories such that they are no longer eligible (such as a personal account migrating to a business account).

The enterprise data warehouse 106 may be configured to generate the eligible subscriber list 108 according to execution of an automated script against the subscriber data housed by the enterprise data warehouse 106. The automated script may be executed periodically (e.g., daily). The enterprise data warehouse 106 may further be configured to execute an automated batch job to extract the filtered eligible subscriber list 108 for use by the system 100 (e.g., to be sent to the service data warehouse 110). The automated batch job may run periodically, such as on a nightly basis after generation of the eligible subscriber list 108. The updating may be performed frequently (e.g., nightly) due to the large volume of subscriber records present (e.g., a subscriber network may have tens or hundreds of millions of subscribers).

The service data warehouse 110 may be configured to support data aspects of the providing various data services to the subscribers of the system 100. For example, the service data warehouse 110 may be configured to facilitate the provisioning of third party data services, such as reporting services for use by marketers delivering targeted advertisements, to the subscriber devices who have not opted out of use of the service.

A privacy notice 112 may be a notice that includes information regarding subscriber consent sufficient to allow the user to make an informed decision regarding whether to opt-out of certain functionality of the system 100. For example, the privacy notice 112 may include information such as an explanation of why the subscriber is receiving the privacy notice 112, what information of the subscriber may be used by the enterprise data warehouse 106, how or with whom the collected subscriber information may be shared, how the collected subscriber information may be used, and what benefits there may be to the subscriber to take advantage of the functionality and not opt-out.

The privacy update services 114 may include a collection of one or more privacy update modules 116 configured to allow subscribers to the subscriber network 104 to update opt-out settings associated with their subscriber devices 102. Exemplary privacy update modules 116 may include: an online subscriber portal module 116-A through which a subscriber may exercise their privacy choice by indicating an opt-out preference selection; a mobile configuration application module 116-B installed on a subscriber's device 102 through which the subscriber may sign into their account and indicate their opt-out preferences; a subscriber express panel module 116-C through which a subscriber may log into a kiosk (e.g., at a retail store affiliated with the subscriber network 104) and indicate their opt-out preferences; an interactive voice response system module 116-D through which a subscriber may call into, authenticate and indicate their opt-out preferences by phone; a retail location sales front-end module 116-E through which a subscriber may authenticate and direct a retail sales representative to set their opt-out preferences; and a retail location customer service front-end module 116-F through which a subscriber may authenticate and direct a retail customer service representative to set their opt-out preferences. Based on input received from the privacy update modules 116, the privacy update services 114 may be configured to send updated privacy information to the billing system 118. In some examples, the privacy update services 114 may commit to performing the update to the billing system 118 within a predetermined period of time, e.g., within twenty-four hours of receipt of subscriber privacy updates.

The billing system 118 may be configured to maintain subscriber billing and privacy preference information. The billing system 118 may further be configured to generate opt-out data 120 containing the list of subscribers who have opted out of the services provided by the service data warehouse 110. For example, the opt-out data 120 may be generated by the billing system 118 by executing an automated script against the maintained subscriber billing and privacy preference information. The automated script may run periodically, such as on a nightly basis. In some cases, the opt-out data 120 may be fully regenerated based on the maintained information. In other cases, the opt-out data 120 may be updated by the automated script to add or remove subscribers from the previous version of the opt-out data 120 based on those subscribers who have updated their privacy choice on that particular period (e.g., that day).

Subscribers may be required to be notified of a privacy notice 112 so that they may be aware of the details of the services and be able to make an informed decision regarding whether to opt-out. In some cases, subscribers may receive an initial notification of privacy notice 112 terms included in a customer service agreement provided to the subscriber when creating the account. In other cases, for example for subscribers who predate a version of the customer service agreement including the privacy notice 112 terms, the subscribers may not receive an initial notification of privacy notice 112 terms. If a subscriber has not received the privacy notice 112, in the interests of protecting subscriber privacy, the system 100 may exclude the subscriber's data from being collected, compiled, or aggregated by the subscriber network 104 and from being used by the third-party or other opt in services.

To perform the notification of subscribers, the system 100 may make use of a notification system 122 configured to provide at least one privacy notice 112 with respect to the opt-out preferences of the subscribers, and to allow a wait period to allow subscribers time to indicate their decision. The wait period may be based on various factors, such as the delivery mode of the privacy notice 112 (e.g., via e-mail, via postal mail), the amount of previous attempts at notification (e.g., subsequent attempts may include a wait of fewer days than previous attempts), as well as any wait periods specified in a customer service agreement previously provided to the subscriber if one was provided. The privacy notices 112 may include privacy notice information for the subscribers or may provide information that may be used to retrieve the privacy notice, such as web address information. Based on the provided privacy notices 112, the notification systems 122 may be configured to determine the subscriber opt-out preferences. For example, if a subscriber is sent a privacy notice 112, and an indication is returned that the privacy notices 112 was not received (e.g., an e-mail bounce-back message for an e-mailed privacy notice 112, lack of notification of an e-mail delivery return-receipt, lack of notification of an e-mail read-receipt, return of an e-mail delivery undeliverable postal mail received back for a postal mail privacy notice 112, etc.), then the notification system 122 may determine that the privacy notice 112 was not received and therefore that the user did not have an opportunity to decide to opt out. In some cases, determination that the privacy notice 112 was not delivered by a particular mechanism (e.g., e-mail) may trigger a further attempt at delivery via a different mechanism (e.g., postal mail as a standalone notification or included as an insert in a customer bill). However, if no indication is received that the subscriber was not provided the privacy notice 112, and the notification system 122 has waited for a wait period to allow the subscriber time to indicate his or her decision, then the notification system 122 may determine that the privacy notice 112 was likely received and that the subscriber did not elect to opt out. Or, if the subscriber provides back an indication to opt out, then then notification system 122 may determine that the user should be opted out.

The notification system 122 may utilize various notification modules 124 configured to provide and manage privacy notices 112. As some exemplary types of notification module 124, the system 100 may include an e-mail notification module 124-A configured to provide e-mail notifications of privacy notices 112 to subscribers of the system 100; a direct mail notification module 124-B configured to provide direct mailing of privacy notices 112 (e.g., standalone privacy notices 112) to the subscribers; an undeliverable postal mail opt-out module 124-C configured to receive and identify the addresses from undeliverable postal privacy notices 112 (e.g., standalone privacy notices 112, privacy notice 112 inserts included with other mailings) and opt those subscribers out as having not been notified; a paper billing notification module 124-D configured to administer paper billing including billing inserts included with customer billings which may include privacy notices 112; and a direct mail for new subscribers module 124-E configured to provide direct mailing privacy notices 112 (e.g., standalone privacy notices 112) to new subscribers as well as subscribers adding additional sub-accounts (e.g., add-a line subscribers) based on data updates to the eligible subscriber list 108.

The service data warehouse 110 may be configured to receive the eligible subscriber list 108 from the enterprise data warehouse 106, receive the opt-out data 120 from the billing system 118, and utilize an inclusion list module 128 to generate a customer inclusion list 126 including a listing of the eligible subscribers that have been notified with a privacy notice 112 and have not opted out of use of their subscriber data usage by third party or other opt in services. The customer inclusion list 126 may include a listing of identifiers of those subscribers who have not opted out and who are otherwise eligible to have the service data warehouse 110 make use of their subscriber data usage for third party services or other opt in services. In some cases, the customer inclusion list 126 may include only the listing of subscriber identifiers (e.g., subscriber MDNs but not additional subscriber information).

As one aspect of the determination of which subscribers to include in the customer inclusion list 126, the inclusion list module 128 may be configured to track in a consent notify list 130 when subscribers were provided the privacy notice 112 by the notification system 122. The consent notify list 130 may include entries for the subscribers of the subscriber network 104 (e.g., indexed according to subscriber identifier such as MDN), and for each entry, may further include recorded sent date 132 information indicative of when information regarding the subscriber was sent to the notification system 122 for notifying the subscriber (or when the privacy notice 112 was sent by the notification system 122), and information indicative of when the subscriber likely received the privacy notice 112 (e.g., no undeliverable e-mail bounce back sent, no undeliverable postal mail returned, affirmative receipt of e-mail delivery return-receipt or e-mail read-receipt). Based on an identified sent date 132 and/or notify date 134 of notification of the subscriber, the inclusion list module 128 may wait a predetermined number of days for the subscriber to consider the privacy notice 112 and make their privacy selection. The predetermined number of days to wait may vary according to various criteria, such as based on terms of a customer service agreement provided to the subscriber when creating the account, the mechanism over which the privacy notice 112 is sent, and whether the privacy notice 112 is the first attempt or a subsequent attempt. In some examples, the inclusion list module 128 may be configured to attempt multiple notifications of each subscriber, thus, the consent notify list 130 may include multiple sent dates 132 and notify dates 134 for each subscriber.

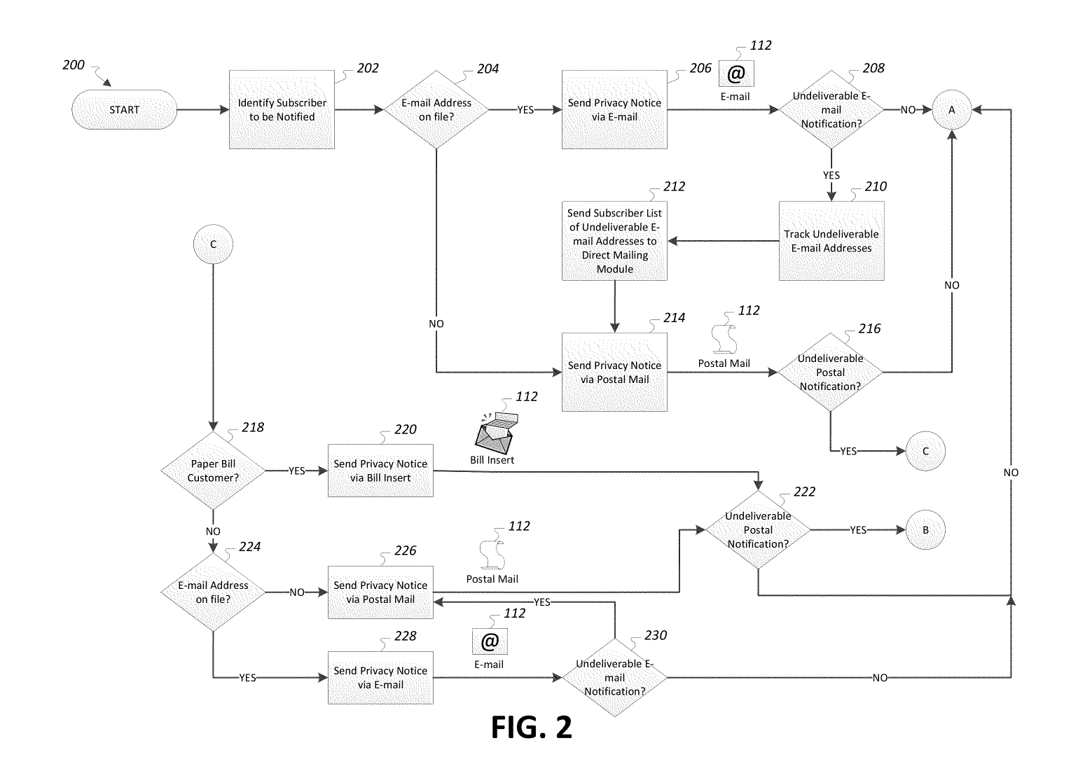

If the inclusion list module 128 determines that there is successful notification for a subscriber, and that subscriber has not opted-out of the program after the predetermined number of days after successful notification, the inclusion list module 128 may define this subscriber as having not opted-out, and begin using his or her information. Thus, the customer inclusion list 126 may include identifiers of subscribers who likely received a privacy notice 112 and did not opt out or who opted in. The customer inclusion list 126 may not include identifiers of subscriber who have not received the privacy notice 112, who received the privacy notice 112 but are within the wait period, or who received privacy notice 112 but opted out. Further aspects of the notification of subscribers are discussed in detail below with respect to FIGS. 2-5.

Data collected from subscribers who are not included on the customer inclusion list 126 may accordingly be purged, not retained, or retained but remain unavailable for use by third-party or other opt in services. Example data that may be collected by the subscriber network 104, and only available for use by third-parties for subscribers included on the customer inclusion list 126, may include subscriber billing information (e.g., for calls, texts, or other communications over the subscriber network), mobile web and application usage (e.g., data indicative of subscribers browser or mobile applications usage on their mobile devices, the data including what sites were visited, what applications were used, lengths of time spend performing the usage), and location information related to where the subscriber is located when the usage is being performed.

The inclusion list module 128 of the service data warehouse 110 may be further configured to consider additional factors (such as subscribers belonging to categories defined as ineligible) in the exclusion of subscribers from the customer inclusion list 126, in addition to the exclusion of subscribers who have not received the privacy notice 112 or who have opted out. As one exemplary possibility for eligibility, an eligible subscriber may be a subscriber who has been provided the appropriate privacy notices 112 and has not opted-out, is a post-paid account, is revenue-generating, and has fewer than a predetermined number of sub-accounts greater than one (e.g., fewer than sixteen as one possibility). As additional exemplary possibilities, an eligible subscriber may be a consumer personal end user or a service provider employee or a subscriber of a small or medium business having fewer than the predetermined number of sub-accounts. Likewise, an ineligible subscriber may be one who has opted-out in response to receipt of a privacy notice 112, has not received a privacy notice 112, is a pre-paid account (and therefore account information may be incomplete or unavailable), is not revenue-generating, is a business account (e.g., the predetermined number of or more sub-accounts on the account), or is government or military account.

The service data warehouse 110 may accordingly use the customer inclusion list 126 to inform the subscriber network 104 of which subscriber devices 102 should or should not have their data collected for use by the third party or other opt-in services, thereby protecting subscriber privacy by excluding any subscribers who have opted out. For example, the subscriber network 104 may utilize the customer inclusion list 126 to only collect or only aggregate subscriber data from subscriber devices associated with identifiers included in the customer inclusion list 126. Additionally or alternately, the generated customer inclusion list 126 may be provided to other third-party services of the system 100 that use the subscriber data, to cause those services to further filter subscriber data to account for cases in which updates the customer inclusion list 126 were not propagated to the subscriber network 104 when the subscriber data was being collected. Other exemplary third-party services using the aggregate subscriber data may include, for example, trending location or dating applications allowing users to receive information about locations that are popular with subscribers having certain characteristics.

FIG. 2 illustrates an exemplary process flow 200 for the providing of privacy notices 112 to a base of subscribers. For example, the process 200 may be performed against each subscriber when a service of a service data warehouse 110 is being rolled out for use by the subscriber base. The process 200 may be performed, for example, by the system 100 discussed above including an inclusion list module 128 being executed by a processor of the service data warehouse 110 to cause the components of the system 100 to perform the operations discussed herein.

The process 200 may be utilized for each of the subscribers of an eligible subscriber list 108 to create a customer inclusion list 126, and gives the subscribers up to two rounds of chances to receive a privacy notice 112. Subscribers on the eligible subscriber list 108 may receive their first round of notices 112 either through e-mail or postal mail, depending on whether a valid e-mail address is on file for the primary account of the subscriber. The delivery method for the second round of notification depends on whether there is success in reaching the subscriber during the first round of notification as well as the subscriber's billing choice. Based on the data of successful notification of the subscriber (e.g., via a first round notification of the privacy notice 112 or a second round notification of the privacy notice 112), the inclusion list module 128 may provide a predetermined number of days for the subscriber to consider the privacy notice 112 to make their privacy selection. In one example, the predetermined number of days is sixty-two (62) days, to allow at least two months for review of the privacy notice 112. As another example, different predetermined number of days may be used for different delivery mechanisms (e.g., the system may provide 14 days for e-mail notification, 30 days after expected delivery of a postal notification, and 30 days after due date of a bill for billing insert notifications). If the inclusion list module 128 determines that there is successful notification for a subscriber, and that subscriber has not opted-out of the program after the predetermined number of days after successful notification, the inclusion list module 128 may interpret this subscriber as not opted-out and allow for the use of his or her approved information.

More specifically, at block 202, the inclusion list module 128 identifies a subscriber that should receive a privacy notice 112. For example, the inclusion list module 128 may iterate through the subscribers of the eligible subscriber list 108. The inclusion list module 128 may further access consent notify list 130 information stored by the service data warehouse 110 to determine to whom privacy notices 112 should be provided. If the consent notify list 130 information for the subscriber indicates that multiple rounds of attempts at delivery of the privacy notice 112 have previously been sent by the notification system 122, then the subscriber may not be selected to receive additional privacy notices 112. For instance, if previous attempts have been made, then the consent notify list 130 may include sent date 132 information recorded by the notification system 122, but if no previous attempts had been made, then the consent notify list 130 may not include any such sent date 132. If the consent notify list 130 information for the subscriber indicates that no privacy notices 112 were previously sent, then the subscriber may be selected to receive a privacy notice 112 and control passes to decision point 204. Otherwise, if one previous attempt has been made, then notifications for the subscriber may still be in process and another subscriber may be selected.

At decision point 204, the inclusion list module 128 determines whether the subscriber to be notified has an e-mail address listed on file. For example, the inclusion list module 128 may review the eligible subscriber list 108 information to determine whether the subscriber has a valid e-mail address on file. E-mail address validity may be initially identified based on whether an e-mail address is of a proper format, e.g., including a username followed by an at-sign, followed by a domain name. If the eligible subscriber list 108 includes an e-mail address for the user, control passes to block 206. Otherwise, control passes to block 214.

At block 206, the inclusion list module 128 directs for an e-mail privacy notice 112 to be sent to the subscriber to the identified e-mail address. For example the inclusion list module 128 may provide the e-mail address to a notification system 122, which may invoke an e-mail notification module 124-A to send the privacy notice 112 to the subscriber via e-mail. The notification system 122 may further provide, to the service data warehouse 110 for inclusion in the consent notify list 130, sent date 132 information indicative of the postal privacy notice 112 being sent in the first round of notification.

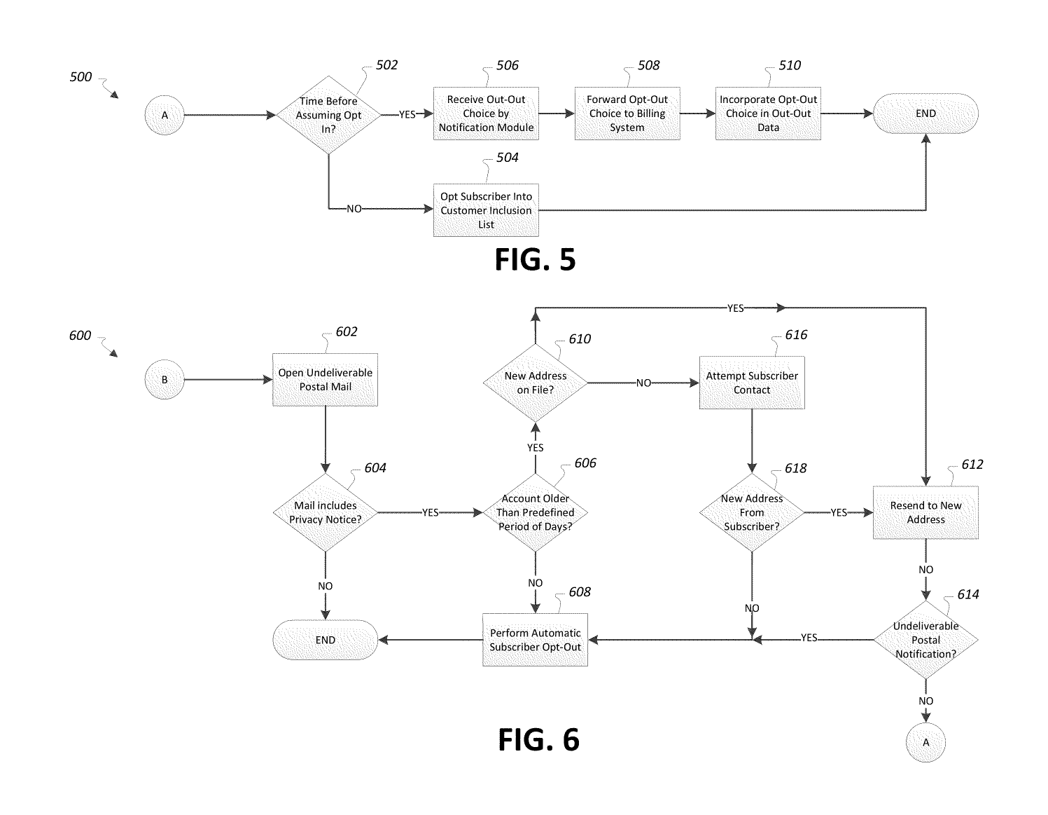

At decision point 208, the notification system 122 determines whether the e-mail privacy notice 112 was undeliverable. For example, the e-mail notification module 124-A of the notification system 122 may receive an e-mail bounce-back message upon sending the privacy notice 112 via e-mail. If the e-mail privacy notice 112 was undeliverable, control passes to block 210. Otherwise, if the e-mail privacy notice 112 appears to have been delivered, control passes to reference (A) to receive an opt-out preference from the subscriber, discussed in detail below in the process 500 illustrated in FIG. 5.

At block 210, the notification system 122 tracks undeliverable e-mail addresses of the subscribers. For example, the e-mail notification module 124-A of the notification system 122 may maintain a listing of subscriber e-mail addresses for which delivery failed by tracking undeliverable mail bounce-back messages, lack of notification of an e-mail delivery return-receipt, or lack of notification of an e-mail read-receipt, as some examples.

At block 212, the notification system 122 provides the listing of subscriber e-mail addresses for which delivery failed to a direct mailing module 124-B. The direct mailing module 124-B may accordingly receive the list of subscribers for which e-mail notification failed.

At block 214, the notification system 122 directs for a postal privacy notice 112 to be sent to the subscriber. For example the inclusion list module 128 may provide the subscriber's postal address to a direct mailing notification module 124-B, and may provide sent date 132 information indicative of the postal privacy notice 112 being sent in the first round of notification. The direct mailing notification module 124-B may send the privacy notice 112 to the subscriber by postal mail.

At decision point 216, the notification system 122 determines whether the postal privacy notice 112 was undeliverable. For example, the direct mailing notification module 124-B may address the postal privacy notice 112 to a postal address of a location for which mail may be received for processing by an undeliverable postal mail module 124-C. If the postal privacy notice 112 is returned to the postal address associated with the undeliverable postal mail module 124-C, the notification system 122 may determine that the postal privacy notice 112 was undeliverable. If the postal privacy notice 112 was indicated as undeliverable, control passes to reference (C) to attempt a second round of subscriber notification. Otherwise, control passes to reference (A).

At decision point 218, from reference (C) to attempt a second round of notification of the subscriber, the inclusion list module 128 determines whether the subscriber is a paper bill customer. For example, the inclusion list module 128 may review electronic notification consent information in the eligible subscriber list 108 information to determine whether the subscriber has opted into electronic notification. For instance, if the subscriber has registered to use the online subscriber portal module 116-A of the service provider, by that registration the subscriber may be expressly agreed to or have been deemed to have consented to electronic notification. If the subscriber is a paper bill customer, control passes to block 220. Otherwise, control passes to decision point 224.

At block 220, the inclusion list module 128 directs for a billing insert privacy notice 112 to be sent to the postal address of the subscriber, accompanying the subscriber's paper bill. For example the inclusion list module 128 may provide the postal address to the notification system 122, which may invoke a paper billing notification module 124-D to send the privacy notice 112 to the subscriber with the next subscriber bill.

At decision point 222, the notification system 122 determines whether the privacy notice 112 was undeliverable. For example, similar to as discussed above at decision point 216, the direct mailing notification module 124-B may determine whether the bill insert privacy notice 112 was returned as undeliverable. If the postal privacy notice 112 was returned as undeliverable, control passes to reference (B), discussed in detail below in the process 600 illustrated in FIG. 6. Otherwise, control passes to reference (A).

At decision point 224, similar to as discussed above with respect to decision point 204, the inclusion list module 128 determines whether the subscriber to be notified has an e-mail address listed on file. For example, if the eligible subscriber list 108 includes an e-mail address for the user, control passes to block 228. Otherwise, control passes to block 226.

At block 226, similar to as discussed above with respect to block 214, the notification system 122 directs for a postal privacy notice 112 to be sent to the subscriber. After block 226, control passes to decision point 222.

At block 228, similar to as discussed above with respect to block 206, the inclusion list module 128 directs for an e-mail privacy notice 112 to be sent to the subscriber to the identified e-mail address.

At decision point 230, similar to as discussed above with respect to decision point 208, the notification system 122 determines whether the e-mail privacy notice 112 was undeliverable. If the e-mail privacy notice 112 was undeliverable, control passes to block 226, to attempt to provide the privacy notice 112 via postal mail. Otherwise, if the e-mail privacy notice 112 appears to have been delivered, control passes to reference (A).

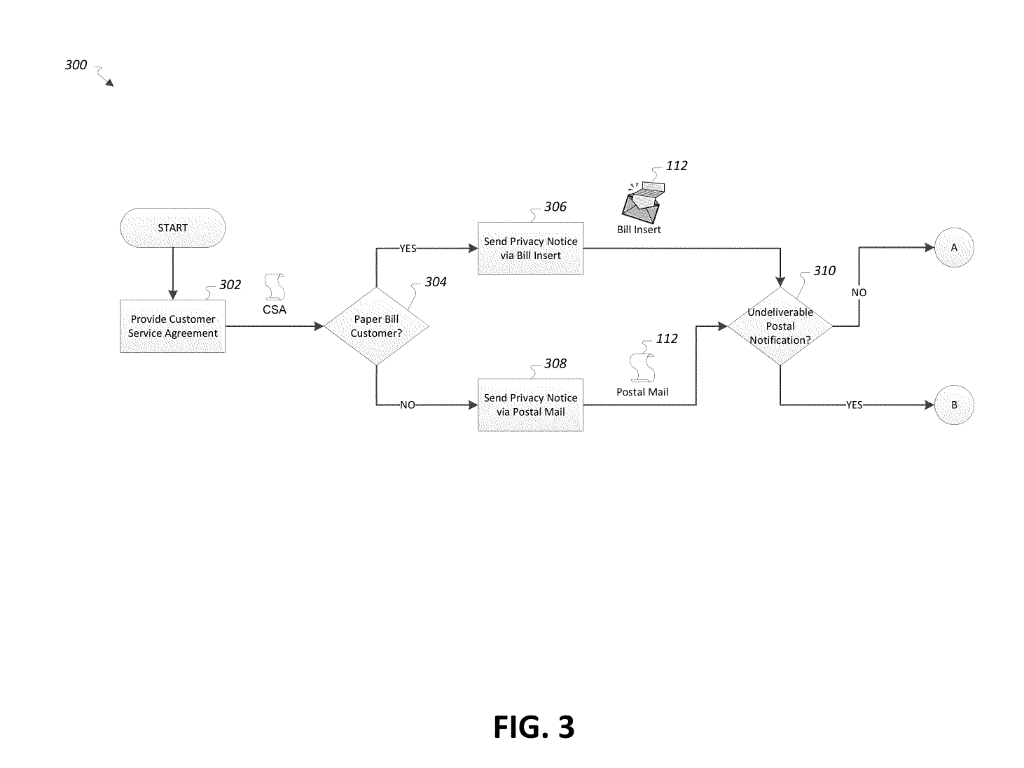

FIG. 3 illustrates an exemplary process flow 300 for the providing of privacy notices 112 for new customers. As with the process 200, the process 300 may be performed by an inclusion list module 128 being executed by a processor of the service data warehouse 110 to cause the components of the system 100 to perform the operations discussed herein. The process 300 may be utilized, for example, for subscribers added to the system 100 after the introduction of a customer service agreement provided to new subscribers to explain system 100 privacy policies.

At block 302, the system 100 provides the customer service agreement to the subscriber. The customer service agreement may provide information to the customer regarding opting-out of functionality, including time periods upon receipt of privacy notices 112. For example, the customer service agreement may provide a predetermined number of days for the subscriber to consider the privacy notice 112 to make their privacy selection. In one example, the predetermined number of days specified by the customer service agreement is seventy-five (75) days. Since the customer service agreement may be utilized as a first notice of the privacy notice 112, the process 300 may only make one further attempt to send the privacy notice 112 to the subscriber (rather than the two attempts of the process 200).

At decision point 304, similar to as discussed above at decision point 218, the inclusion list module 128 determines whether the subscriber is a paper bill customer. If so, control passes to block 306. Otherwise control passes to block 308.

At block 306, similar to as discussed above at block 220, the inclusion list module 128 directs for a billing insert privacy notice 112 to be sent to the subscriber to the postal address of the subscriber accompanying the subscriber's paper bill. After block 306, control passes to decision point 310.

At block 308, similar to as discussed above at block 214, the inclusion list module 128 directs for a postal privacy notice 112 to be sent to the subscriber to the postal address of the subscriber accompanying the subscriber's paper bill. After block 308, control passes to decision point 310.

At decision point 310, similar to as discussed above at decision point 222, the notification system 122 determines whether the privacy notice 112 was undeliverable. If the postal privacy notice 112 was indicated as undeliverable, control passes to reference (B). Otherwise, control passes to reference (A).

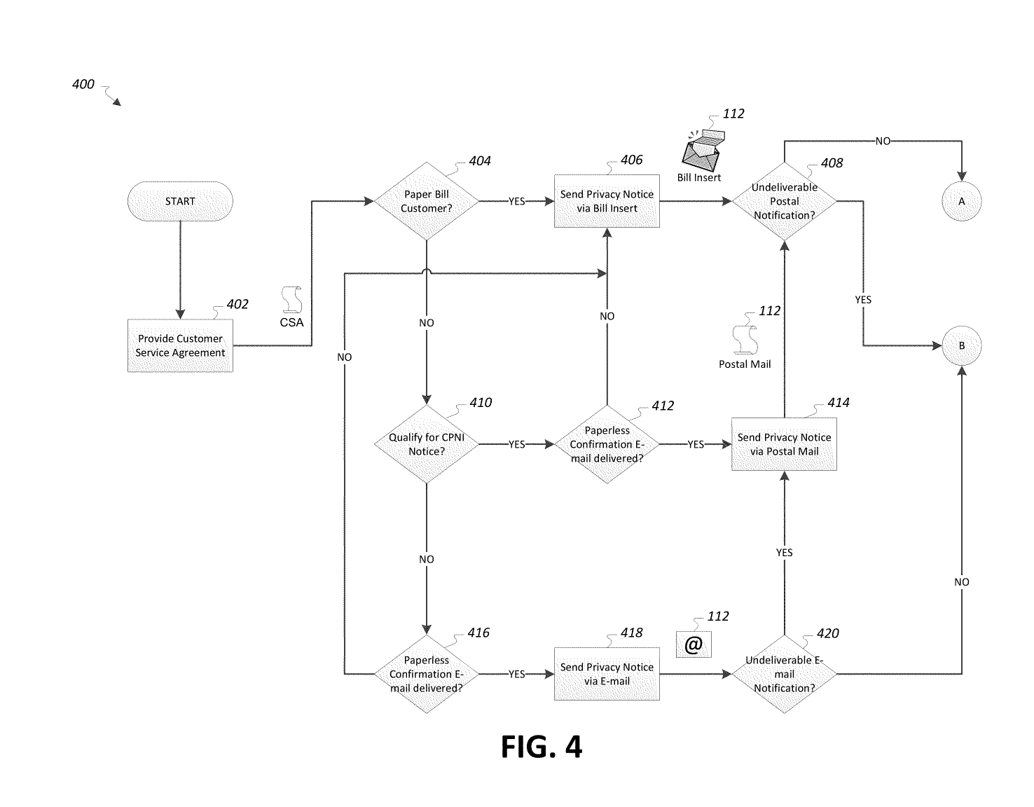

FIG. 4 illustrates an exemplary process flow 400 for the providing of privacy notices 112 for the addition of subscriber sub-accounts. As with the processes 200 and 300, the process 400 may be performed by an inclusion list module 128 being executed by a processor of the service data warehouse 110 to cause the components of the system 100 to perform the operations discussed herein. As with the process 300, the process 400 may be utilized for subscribers who are being added to the system after the introduction of a customer service agreement that is provided to new subscribers to explain privacy policies of the system 100.

At block 402, similar to as discussed above at block 302, the system 100 provides the customer service agreement to the subscriber.

At decision point 404, similar to as discussed above at decision point 218, the inclusion list module 128 determines whether the subscriber is a paper bill customer. If the subscriber is a paper bill customer, control passes to block 406. Otherwise, control passes to decision point 410.

At block 406, similar to as discussed above at block 220, the inclusion list module 128 directs for a billing insert privacy notice 112 to be sent to the postal address of the subscriber, accompanying the subscriber's paper bill.

At decision point 408, similar to as discussed above at decision point 222, the notification system 122 determines whether the privacy notice 112 was undeliverable. If the postal privacy notice 112 was indicated as undeliverable, control passes to reference (B). Otherwise, control passes to reference (A).

At decision point 410, the inclusion list module 128 determines whether the customer qualifies for a customer proprietary network information (CPNI) notification. CPNI information may be defined as information created by virtue of a subscriber's relationship with the service provider. This information may include services purchased (including specific communications made or received by a subscriber over the subscriber network 104 using his or her subscriber devices 102), related local and toll billing information, the type, destination, technical configuration, location and amount of use of purchased services. Rules on whether a subscriber should receive a CPNI may vary based on the state of residence of the subscriber. Accordingly, the inclusion list module 128 may review postal address information in the eligible subscriber list 108 information to determine whether the subscriber should receive a CPNI notification. If the subscriber qualifies for a CPNI notification, control passes to decision point 412. Otherwise, control passes to decision point 416.

At decision point 412, the inclusion list module 128 determines whether an e-mail confirmation provided when the subscriber selected paperless billing was successfully received. For example, the inclusion list module 128 may review paperless confirmation information in the eligible subscriber list 108 information to determine whether a paperless confirmation e-mail message was successfully received (e.g., without receipt of an undeliverable e-mail bounce-back). If the e-mail confirmation was successfully provided to the subscriber, control passes to block 414. Otherwise, control passes to block 406.

At block 414, similar to as discussed above at block 206, the inclusion list module 128 directs for a billing insert privacy notice 112 to be sent standalone to the subscriber to the postal address of the subscriber, as the subscriber does not receive paper bills. Notably, the privacy notice 112 directed for delivery includes a combined CPNI and privacy notice 112, not merely a privacy notice 112 alone.

At decision point 416, similar to as discussed above at decision point 412, the inclusion list module 128 determines whether an e-mail confirmation provided when the subscriber selected paperless billing was successfully sent. If the e-mail confirmation was successfully provided to the subscriber, control passes to block 418. Otherwise, control passes to block 406 to provide the privacy notice 112 as a billing insert.

At block 418, similar to as discussed above with respect to block 206, as no CPNI notification is required, and as the subscriber does not receive paper bills, the notification system 122 directs for an e-mail privacy notice 112 to be sent to the subscriber.

At decision point 420, similar to as discussed above at decision point 208, the notification system 122 determines whether the e-mail privacy notice 112 was undeliverable. If the e-mail privacy notice 112 was undeliverable, control passes to block 414, to attempt to provide the privacy notice 112 via postal mail. Otherwise, if the e-mail privacy notice 112 appears to have been delivered, control passes to reference (A).

FIG. 5 illustrates an exemplary process flow 500 for the updating of opt-out data 120 according to subscriber updates. Control may pass to the process 500 performed by the system 100, upon reaching any of the references (A) discussed in detail above and below.

At decision point 502, the privacy update services 114 of the system 100 determine whether additional time remains before assuming the subscriber may be opted in. For example, if the privacy update services 114 has not received any opt-out preferences for the user for a predetermined number of days (e.g., a default number of days for users not receiving a customer service agreement, a number of days specified in a customer service agreement provided to the subscriber), the privacy update services 114 may assume that the subscriber consents to use of his or her data. If opt-out preferences are received from the subscriber within the time period, control passes to block 506. If not, control passes to block 504.

At block 504, the privacy update services 114 of the system 100 opts the user into inclusion in the customer inclusion list 126. After block 504, the process 500 ends.

At block 506, the privacy update services 114 of the system 100 receive an opt-out preference from a subscriber. To provide the opt-out preference, the subscriber may utilize one or more privacy update modules 116 of the privacy update services 114 to update opt-out settings associated the subscriber's subscriber devices 102. For instance, the subscriber may perform one or more of: accessing an online subscriber portal module 116-A using a web browser to indicate an opt-out preference selection; using a mobile configuration application module 116-B installed on the subscriber's device 102 to sign into the subscriber's account and indicate an opt-out preference; logging into a kiosk of a retail store affiliated with the subscriber network 104 to a subscriber express panel module 116-C to indicate an opt-out preference; calling into an interactive voice response system module 116-D to speak or enter an opt-out preference by phone (e.g., using dual-tone multi-frequency signaling); authenticating into a retail location sales front-end module 116-E to direct a retail sales representative to set an opt-out preference; and authenticating into a retail location customer service front-end module 116-F to direct a customer service representative to set an opt-out preference for the subscriber.

At block 508, the privacy update services 114 provide the updated opt-out preferences regarding the subscriber to the billing system 118. In some examples, the privacy update services 114 may commit to performing the update to the billing system 118 within a predetermined period of time, e.g., within twenty-four hours of receipt of subscriber privacy updates.

At block 510, the billing system 118 incorporates the updated opt-out preference into the opt-out data 120. The billing system 118 may accordingly account for the updated opt-out preferences with generating the opt-out data 120 containing the list of subscribers who have opted out of the services provided by the service data warehouse 110. After block 510, the process 500 ends.

FIG. 6 illustrates an exemplary process flow 600 for the automatic removal of subscribers from inclusion in the customer inclusion list 126. Control may pass to the process 600 performed by the system 100, upon reaching any of the references (B) discussed in detail above.

At block 602, the notification system 122 directs for a received item of undeliverable postal mail received back for a postal mail privacy notice 112 to be opened. For example, a postal address of a location for which mail may be received for processing by the undeliverable postal mail module 124-C may be listed as the return address of the postal privacy notice 112, and the undeliverable postal mail module 124-C may request for the undeliverable mail to be opened.

At decision point 604, the notification system 122 determines whether the received item of undeliverable postal mail includes a privacy notice 112. For example, the undeliverable postal mail module 124-C may receive an indication from the location for which undeliverable postal mail is received regarding the contents of the undeliverable postal mail requested to be opened. The undeliverable postal mail module 124-C may further receive an indication that the undeliverable postal mail includes a bill insert privacy notice 112 or a standalone postal mail privacy notice 112. If the undeliverable postal mail includes a privacy notice 112, control passes to block 606. Otherwise, the mail fails to indicate a status regarding delivery of the privacy notice 112, and the process 600 ends.

At decision point 606, the notification system 122 determines whether the subscriber account to which the undelivered privacy notice 112 was sent is older than a predetermined number of days. For example, the undeliverable postal mail module 124-C may determine whether the subscriber account is older than a billing period (e.g., 30 days old) by querying the enterprise data warehouse 106 for subscriber information regarding the creation date of the account. If the subscriber account is not older than the predetermined number of days, control passes to block 608. Otherwise, control passes to decision point 610.

At block 608, the notification system 122 informs the system 100 that the subscriber should be opted out. For example, similar to as discussed above at block 504, the undeliverable postal mail module 124-C may utilize one of the privacy update modules 116 of the privacy update services 114 to update opt-out settings associated the subscriber's subscriber devices 102 to update the opt-out preferences for the subscriber. As another example, the undeliverable postal mail module 124-C may provide information to the billing system 118 without utilizing the privacy update modules 116 or the privacy update services 114. Further, similar to as discussed above at block 506, the billing system 118 incorporates the updated opt-out preference into the opt-out data 120. After block 608, the process 600 ends. In some cases, if the subscriber account is not older than the predetermined number of days discussed above with respect to decision point 606, the notification system 122 may provisionally opt-out the subscriber, and schedule a further round of notification of the subscriber of the privacy notice 112 at a later date, e.g., at the beginning of the next billing period.

At decision point 610, the notification system 122 determines whether a new address is on file for the subscriber to which the undelivered privacy notice 112 was sent. For example, the undeliverable postal mail module 124-C may query the enterprise data warehouse 106 to determine whether a current postal address different from the one noted on the undelivered privacy notice 112 is included in the eligible subscriber list 108 information. If a different current postal address is on file, control passes to block 612. Otherwise, control passes to block 616.

At block 612, the undeliverable postal mail module 124-C resends the undelivered privacy notice 112 to the current address of the subscriber. For example, similar to as discussed above at block 214 (e.g., for standalone postal privacy notices 112) or block 220 (e.g., for billing insert privacy notices 112), the undeliverable postal mail module 124-C may direct for the privacy notice 112 to be resent to the new current postal address.

At decision point 614, similar to as discussed above at decision point 216, the notification system 122 determines whether the postal privacy notice 112 was undeliverable. If the privacy notice 112 was indicated as undeliverable, control passes to block 608 to automatically opt the subscriber out. Otherwise, control passes to reference (A) to receive an opt-out preference from the subscriber, as described above in the process 500.

At block 616, the notification system 122 attempts subscriber contact as no new address is on file for the subscriber. For example, the undeliverable postal mail module 124-C may query the enterprise data warehouse 106 to determine a phone number for the subscriber, and may call the phone number to attempt to notify the subscriber to update his or her postal address information or to receive updated address information from the subscriber during the call.

At decision point 618, the notification system 122 determined whether a new current address for the subscriber is received. For example, a new current address may be received from the subscriber during attempted subscriber contact, or updated in the enterprise data warehouse 106 by the subscriber within a predetermine period of time (e.g., within twenty-four hours) from making the attempted contact. If a new current address is available, control passes to block 612 to resend the privacy notice 112 to the new postal address. Otherwise, control passes to block 608 to perform an automatic opt-out of the subscriber.

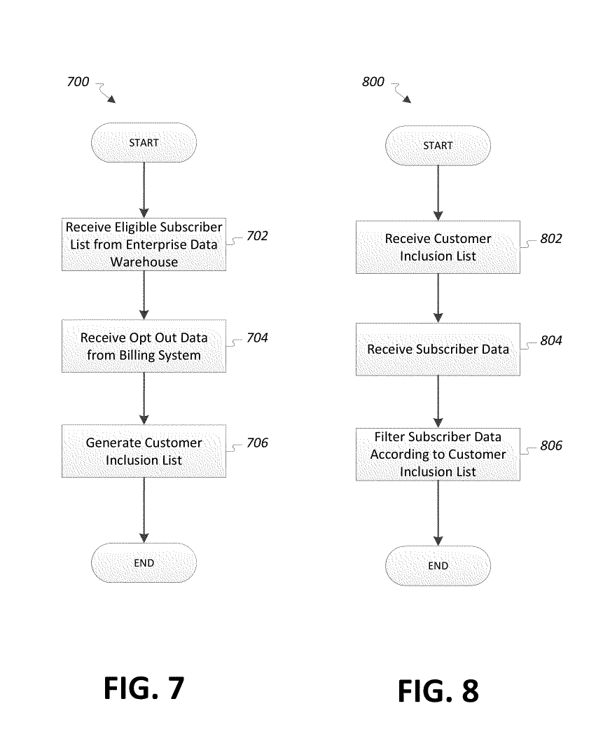

FIG. 7 illustrates an exemplary process 700 for generation of the customer inclusion list 126. The process 700 may be performed, for example, by an inclusion list module 128 of a service data warehouse 110 in communication with an enterprise data warehouse 106 and a billing system 118 of system 100.

At block 702, the inclusion list module 128 of the service data warehouse 110 receives an eligible subscriber list 108 from the enterprise data warehouse 106. For example, the enterprise data warehouse 106 may be configured to exclude a number of categories of subscribers defined as being ineligible from the eligible subscriber list 108. These categories may include business account holders (identified by accounts with an indicator that it is receiving a corporate discount, or accounts with more than the predetermined number of sub-accounts or lines), federal/state/local government accounts, and pre-paid accounts, as some examples. Moreover, accounts that have disconnected from the service or changed categories such that they are no longer eligible (such as a personal account migrating to a business account) may also be excluded. The service data warehouse 110 may be configured to generate the eligible subscriber list 108 according to execution of an automated script against the subscriber data housed by the enterprise data warehouse 106, and may be further be configured to execute an automated batch job to extract the filtered eligible subscriber list 108 to be sent to the service data warehouse 110 either automatically or upon service data warehouse 110 request. The inclusion list module 128 may accordingly receive the updated eligible subscriber list 108.

At block 704, the inclusion list module 128 of the service data warehouse 110 receives opt-out data 120 from the billing system 118. For example, the billing system 118 may be configured to generate the opt-out data 120 upon execution of an automated script against maintained subscriber billing and privacy preference information. The billing system 118 may periodically generate new opt-out data 120 periodically (e.g., nightly) based on received opt-out preferences, and may provide the updated opt-out data 120 to the service data warehouse 110 either automatically or upon request by the service data warehouse 110. The inclusion list module 128 may accordingly receive the updated eligible subscriber list 108.

At block 706, the inclusion list module 128 of the service data warehouse 110 generates the customer inclusion list 126. For example, inclusion list module 128 may be configured to map the eligible subscriber list 108 received from the service data warehouse 110 with the opt-out data 120 from the billing system 118, and drop records from the eligible subscriber list 108 for those subscribers who are opted out. An exemplary customer inclusion list 126 may include identifiers of subscriber devices 102, such as a listing of subscriber MDNs, and in many cases includes only the identifiers. The customer inclusion list 126 may then be used by services of the system to respect subscriber privacy regarding use of their data. For example the reporting services of the service data warehouse 110 and/or other services of the system 100 may utilize the customer inclusion list 126 to ensure data from subscribers who opted-out is not used. After block 706, the process 700 ends.

FIG. 8 illustrates an exemplary process 800 for utilization of the customer inclusion list 126 to filter subscriber data for use by opt-in services. The process 800 may be performed, for example, by a subscriber network 104 in communication with a plurality of subscriber devices 102 and the service data warehouse 110.

At block 802, the subscriber network 104 receives the customer inclusion list 126 from the service data warehouse 110. The customer inclusion list 126 may be generated, for example, by way of the process 700 discussed above. The customer inclusion list 126 may include a listing of identifiers of those subscribers who have not opted out and who are otherwise eligible to have the service data warehouse 110 make use of their subscriber data usage for third party services or other opt in services. In some cases, the customer inclusion list 126 may include only the listing of subscriber identifiers (e.g., subscriber MDNs but not additional subscriber information).

At block 804, the subscriber network 104 receives subscriber data regarding subscriber devices 102. Example subscriber data that may be collected by the subscriber network 104 may include subscriber billing information (e.g., for calls, texts, or other communications over the subscriber network), mobile web and application usage (e.g., data indicative of subscribers browser or mobile applications usage on their mobile devices, the data including what sites were visited, what applications were used, lengths of time spend performing the usage), and location information related to where the subscriber is located when the usage is being performed.

At block 806, the subscriber network 104 filters the subscriber data according to the customer inclusion list 126. For example, the subscriber network 104 may filter out data from subscriber devices 102 on the subscriber network 104 that are not associated with a device identifier included on the customer inclusion list 126. Thus, by using the customer inclusion list 126, the subscriber network 104 will respect to the data privacy of subscribers who have not opted into use of their data for third-party or other opt in services of the system 100. After block 806, the process 800 ends.

Thus, the system 100 may provide an opt-in mechanism to allow subscribers to opt into use of their information by services of the system 100. The system 100 may be configured to provide privacy notices 112 to subscribers of the system using a notification system including one or more notification modules 124, and to receive opt-out preferences from the subscribers utilizing privacy update services 114 including one or more privacy update modules 116. A billing system 118 may receive the opt-out preferences of the subscriber, and may compile opt-out data 120. An enterprise data warehouse 106 may filter stored subscriber data to create a filtered eligible subscriber list 108 of those subscribers who may use the services of the system 100. An inclusion list module 128 of a service data warehouse may receive the eligible subscriber list 108 and the opt-out data 120 and may compile a customer inclusion list 126 including identifiers of the subscribers opted into use of the services of the system 100. The customer inclusion list 126 may accordingly be used by the services to allow the services to operate only on data of those subscribers who have not opted out of use of their data for system 100 services.

In general, computing systems and/or devices, such as the enterprise data warehouse 106, service data warehouse 110, privacy update services 114, billing system 118 and notification system 122, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices, such as the enterprise data warehouse 106, service data warehouse 110, privacy update services 114, billing system 118 and notification system 122, generally include computer-executable instructions such as the instructions of the privacy update modules 116, notification modules 124 and inclusion list module 128, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein, such as data stored by the enterprise data warehouse 106, service data warehouse 110 and billing system 118, may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a service data warehouse configured to execute an inclusion list module to perform operations comprising:
receiving opt-out data from a billing system of a subscriber network, the opt-out data associated with use of subscriber information by at least one third-party information service;
receiving an eligible subscriber list from an enterprise data warehouse of the subscriber network; and
generating a customer inclusion list from the eligible subscriber list and the opt-out data, the customer inclusion list including a listing of subscriber identifiers of subscribers of the subscriber network who have opted into use of the at least one third-party information service of the subscriber network.

2. The system of claim 1, wherein:
the enterprise data warehouse is configured to filter stored subscriber data to create the eligible subscriber list, the filtering including excluding at least two of: business accounts receiving a corporate discount, accounts with more than a predetermined number of sub-accounts, government accounts, and pre-paid accounts; and
the billing system is configured to generate the opt-out data from a previous version of the opt-out data by modifying the previous version of the opt-out data according to subscriber opt-out preferences received by the billing system since creation of the previous version of the opt-out data.

3. The system of claim 2, further comprising at least one privacy update module configured to:
receive the subscriber opt-out preferences from at least one subscriber included on the eligible subscriber list, and
provide the received subscriber opt-out preferences to the billing system.

4. The system of claim 1, wherein the service data warehouse is further configured to execute the inclusion list module to perform operations comprising providing the customer inclusion list to a marketing data reporting service of the subscriber network, the reporting service configured to filter subscriber data for reports to include only subscriber data for the subscriber identifiers appearing on the customer inclusion list.

5. The system of claim 1, further comprising a notification system configured to perform operations comprising:
providing a privacy notice to a subscriber included on the eligible subscriber list as a bill insert when the subscriber is a paper bill customer,
providing the privacy notice to the subscriber as an e-mail when the subscriber has an e-mail address on file, and
providing the privacy notice as a postal letter if the subscriber is not a paper bill customer and does not have the e-mail address on file.

6. The system of claim 5, the notification system further configured to perform operations comprising at least one of:
(i) performing an automatic opt-out of a subscriber based on a determination that the privacy notice is undeliverable,
(ii) attempting subscriber contact to receive current subscriber address information based on receipt of the privacy notice as undeliverable,
(iii) providing the privacy notice as a postal letter upon receipt of notification of an undeliverable e-mail privacy notice, and performing an automatic opt-out of a subscriber based on receipt of the postal letter as undeliverable, and
(iv) providing a second privacy notice to the subscriber before performing the automatic opt-out of a subscriber for subscribers indicated as not having received a copy of a customer service agreement.

7. The system of claim 5, the notification system further configured to perform operations comprising waiting a predetermined number of days for the subscriber to consider the privacy notice before automatically opting the subscriber into inclusion in the customer inclusion list.

8. A method, comprising:
receiving, from an inclusion list module executed by a service data warehouse, opt-out data from a billing system of a subscriber network, the opt-out data associated with use of subscriber information by at least one third-party information service;
receiving, by the inclusion list module, an eligible subscriber list from an enterprise data warehouse of the subscriber network; and
generating, by the inclusion list module, a customer inclusion list from the eligible subscriber list and the opt-out data, the customer inclusion list including a listing of subscriber identifiers of subscribers of the subscriber network who have opted into use of the at least one third-party information service of the subscriber network.

9. The method of claim 8, further comprising:
filtering, by the enterprise data warehouse, stored subscriber data to create the eligible subscriber list, the filtering including excluding at least two of: business accounts receiving a corporate discount, accounts with more than a predetermined number of sub-accounts, government accounts, and pre-paid accounts; and
generating, by the billing system, the opt-out data from a previous version of the opt-out data by modifying the previous version of the opt-out data according to subscriber opt-out preferences received by the billing system since creation of the previous version of the opt-out data.

10. The method of claim 9, further comprising:
receiving, using at least one privacy update module, the subscriber opt-out preferences from at least one subscriber included on the eligible subscriber list; and
providing the received subscriber opt-out preferences from the privacy update module to the billing system.

11. The method of claim 8, further comprising providing the customer inclusion list to a marketing data reporting service of the subscriber network, the reporting service filtering subscriber data for reports to include only subscriber data for the subscriber identifiers appearing on the customer inclusion list.

12. The method of claim 8, further comprising:
providing a privacy notice to a subscriber included on the eligible subscriber list as a bill insert when the subscriber is a paper bill customer,
providing the privacy notice to the subscriber as an e-mail when the subscriber has an e-mail address on file, and
providing the privacy notice as a postal letter if the subscriber is not a paper bill customer and does not have the e-mail address on file.

13. The method of claim 12, further comprising at least one of:
(i) performing an automatic opt-out of a subscriber based on a determination that the privacy notice is undeliverable,
(ii) attempting subscriber contact to receive current subscriber address information based on receipt of the privacy notice as undeliverable,
(iii) providing the privacy notice as a postal letter upon receipt of notification of an undeliverable e-mail privacy notice, and performing an automatic opt-out of a subscriber based on receipt of the postal letter as undeliverable, and
(iv) providing a second privacy notice to the subscriber before performing the automatic opt-out of a subscriber for subscribers indicated as not having received a copy of a customer service agreement.

14. The method of claim 12, further comprising waiting a predetermined number of days for the subscriber to consider the privacy notice before automatically opting the subscriber into inclusion in the customer inclusion list.

15. A non-transitory computer-readable medium tangibly embodying computer-executable instructions that when executed by a processor cause the processor to perform operations comprising:
receiving, from an inclusion list module executed by a service data warehouse, opt-out data from a billing system of a subscriber network, the opt-out data associated with use of subscriber information by at least one third-party information service;
receiving, by the inclusion list module, an eligible subscriber list from an enterprise data warehouse of the subscriber network; and
generating, by the inclusion list module, a customer inclusion list from the eligible subscriber list and the opt-out data, the customer inclusion list including a listing of subscriber of the subscriber network who have identifiers of subscribers opted into use of the at least one third-party information service of the subscriber network.

16. The non-transitory computer-readable medium of claim 15, further including instructions to cause the processer to perform operations comprising:
filtering stored subscriber data to create the eligible subscriber list, the filtering including excluding at least two of: business accounts receiving a corporate discount, accounts with more than a predetermined number of sub-accounts, government accounts, and pre-paid accounts; and
generating the opt-out data from a previous version of the opt-out data by modifying the previous version of the opt-out data according to subscriber opt-out preferences received since creation of the previous version of the opt-out data.

17. The non-transitory computer-readable medium of claim 16, further including instructions to cause the processer to perform operations comprising:
receiving, using at least one privacy update module, the subscriber opt-out preferences from at least one subscriber included on the eligible subscriber list; and
providing the received subscriber opt-out preferences from the privacy update module to the billing system.

18. The non-transitory computer-readable medium of claim 15, further including instructions to cause the processer to perform operations comprising providing the customer inclusion list to a marketing data reporting service of the subscriber network, the reporting service filtering subscriber data for reports to include only subscriber data for the subscriber identifiers appearing on the customer inclusion list.

19. The non-transitory computer-readable medium of claim 15, further including instructions to cause the processer to perform operations comprising:
providing a privacy notice to a subscriber included on the eligible subscriber list as a bill insert when the subscriber is a paper bill customer,
providing the privacy notice to the subscriber as an e-mail when the subscriber has an e-mail address on file, and
providing the privacy notice as a postal letter if the subscriber is not a paper bill customer and does not have the e-mail address on file.

20. The non-transitory computer-readable medium of claim 19, further including instructions to cause the processer to perform operations comprising at least one of:
(i) performing an automatic opt-out of a subscriber based on a determination that the privacy notice is undeliverable,
(ii) attempting subscriber contact to receive current subscriber address information based on receipt of the privacy notice as undeliverable,
(iii) providing the privacy notice as a postal letter upon receipt of notification of an undeliverable e-mail privacy notice, and performing an automatic opt-out of a subscriber based on receipt of the postal letter as undeliverable, and
(iv) providing a second privacy notice to the subscriber before performing the automatic opt-out of a subscriber for subscribers indicated as not having received a copy of a customer service agreement.

21. The non-transitory computer-readable medium of claim 19, further including instructions to cause the processer to perform operations comprising waiting a predetermined number of days for the subscriber to consider the privacy notice before automatically opting the subscriber into inclusion in the customer inclusion list.
